(19) United States
(12) Patent Application Publication
(10) Pub. No.: US 2009/0128037 A1
(43) Pub. Date: May 21, 2009

(54) Plasma display panel and manufacturing method of same

(76) Inventors: Jung-Suk Song, Suwon-si (KR); Seong-Hun Choo, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/289,964

(22) Filed: Nov. 7, 2008

(30) Foreign Application Priority Data
Nov. 19, 2007 (KR) 10-2007-0117981

(51) Int. Cl. H01J 17/49; H01J 9/20

(52) U.S. Cl. 313/587; 445/24

(57) ABSTRACT

A plasma display panel (PDP) includes front and rear substrates spaced apart and facing each other, a plurality of display electrodes along a first direction on the front substrate, a plurality of address electrodes along a second direction on the rear substrate, the second direction crossing the first direction, a dielectric layer on the rear substrate to cover the address electrodes, barrier ribs between the front and rear substrates to define a plurality of discharge cells, a bottom surface of the barrier ribs being on the dielectric layer, and a phosphor layer on the dielectric layer, at least one portion of the phosphor layer being arranged between the dielectric layer and the bottom surface of the barrier ribs.

### BACKGROUND OF THE INVENTION

1. Field of the Invention

Embodiments of the present invention relate to a plasma display panel (PDP). More particularly, embodiments of the present invention relate to a PDP including a barrier rib on a phosphor layer.

2. Description of the Related Art

In general, a PDP may refer to a display panel using vacuum ultraviolet (VUV) light emitted from plasma obtained with gas discharge. The VUV light may excite phosphors, and the excited phosphors may emit visible light upon stabilization. The visible light may include red (R) light, green (G) light, and/or blue (B) light according to a type of phosphor, and the emitted R, G, and B lights may be combined to realize an image.

A conventional PDP, e.g., an AC-type PDP, may include two substrates facing each other with a plurality of electrodes therebetween, barrier ribs between the two substrates to define discharge cells, and phosphors on the barrier ribs. The conventional phosphors may be formed after formation of all the barrier ribs is complete, so the phosphors may be formed on upper surfaces of the barrier ribs, i.e., surfaces facing one of the substrates.

Phosphors on the upper surfaces of the barrier ribs, however, may generate unnecessary visible light or may generate a misfiring discharge, so image quality of the PDP may deteriorate. Further, when the phosphors are provided on the upper surfaces of the barrier ribs, a gap may be generated between the barrier ribs and a front substrate, i.e., a substrate facing the phosphors, so noise and crosstalk between the discharge cells may be generated.

The above information disclosed in this Background section is only for enhancement of understanding of the background of the invention and therefore it may contain information that does not form the prior art that is already known in this country to a person of ordinary skill in the art.

### SUMMARY OF THE INVENTION

Embodiments of the present invention are therefore directed to a PDP and a method of manufacturing the same, which substantially overcome one or more of the disadvantages and shortcomings of the related art.

It is therefore a feature of an embodiment of the present invention to provide a PDP having barrier ribs on a phosphor layer, so misfiring discharge may be reduced.

It is another a feature of an embodiment of the present invention to provide a method of manufacturing a PDP having barrier ribs formed on the phosphor layer, so noise and crosstalk between discharge cells is reduced.

At least one of the above and other features and advantages of the present invention may be realized by providing a PDP, including front and rear substrates spaced apart and facing each other, a plurality of display electrodes along a first direction on the front substrate, a plurality of address electrodes along a second direction on the rear substrate, the second direction crossing the first direction, a dielectric layer on the rear substrate to cover the address electrodes, barrier ribs between the front and rear substrates to define a plurality of discharge cells, a bottom surface of the barrier ribs being on the dielectric layer, and a phosphor layer on the dielectric layer, at least one portion of the phosphor layer being arranged between the dielectric layer and the bottom surface of the barrier ribs. The barrier ribs may include first barrier rib members extending directly on the dielectric layer and second barrier rib members arranged directly on the phosphor layer along a direction crossing a direction of the first barrier rib members, the at least one portion of the phosphor layer being positioned between the dielectric layer and a bottom surface of the second barrier rib members.

The phosphor layer may overlap and be in direct contact with three surfaces or less of the second barrier rib members. The phosphor layer may overlap and be in direct contact with the bottom surfaces and outer surfaces of the second barrier rib members, the outer surfaces of the second barrier rib members facing the first barrier rib members. The phosphor layer may overlap and be in direct contact only with the bottom surfaces of the second barrier rib members. The phosphor layer may not be on upper surfaces or inner surfaces of the second barrier rib members, the upper surfaces of the second barrier rib members being opposite the bottom surfaces, and the inner surfaces of the second barrier rib members defining inner sidewalls of the discharge cells. The phosphor layer may not be on upper surfaces or inner surfaces of the first barrier rib members. The at least one portion of the phosphor layer may be arranged between a second barrier rib member and an immediately adjacent first barrier rib member. Each second barrier rib member may include a plurality of discrete barrier rib segments, each barrier rib segment being positioned directly on the phosphor layer between two adjacent first barrier rib members. The dielectric layer may include a groove along the second direction, the phosphor layer being in the groove.

At least one of the above and other features and advantages of the present invention may be also realized by providing a method of manufacturing a PDP, including forming a plurality of display electrodes along a first direction on a front substrate, forming a plurality of address electrodes along a second direction on a rear substrate, the front and rear substrates spaced apart and facing each other, forming a dielectric layer on the rear substrate to cover the address electrodes, forming barrier ribs between the front and rear substrates to define a plurality of discharge cells, such that a bottom surface of the barrier ribs is on the dielectric layer, and forming a phosphor layer on the dielectric layer, such that at least one portion of the phosphor layer is formed between the dielectric layer and the bottom surface of the barrier ribs.

Forming the barrier ribs and the phosphor layer may include forming first barrier rib members on the dielectric layer, the first barrier ribs being spaced apart from each other, forming the phosphor layer between adjacent first barrier rib members, the phosphor layer being on the dielectric layer and on sidewalls of the first barrier rib members, and forming second barrier rib members on the phosphor layer. Forming the second barrier rib members may include using a mold. Forming the second barrier rib members may include dispensing a barrier rib forming paste. Forming the phosphor layer may include dispensing a phosphor paste. Forming the barrier ribs and the phosphor layer may include forming a groove in the dielectric layer along the second direction, forming the phosphor layer in the groove, and forming the barrier ribs on the rear substrate, at least a portion of the barrier ribs overlapping the phosphor layer.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates an exploded perspective view of a PDP according to an exemplary embodiment of the present invention;

FIG. 2 illustrates an exploded perspective view of a phosphor layer with respect to the barrier ribs illustrated in FIG. 1;

FIG. 3 illustrates a cross-sectional view of a PDP along line III-III of FIG. 1;

FIG. 4 illustrates a cross-sectional view of a PDP along line IV-IV of FIG. 1;

FIG. 5 illustrates a manufacturing flowchart of a PDP according to an exemplary embodiment of the present invention;

FIGS. 6A-6C illustrate cross-sectional views of sequential stages in a method of manufacturing a PDP according to an embodiment of the present invention;

FIG. 7 illustrates an exploded perspective view of a PDP according to another exemplary embodiment of the present invention;

FIG. 8 illustrates an exploded perspective view of a phosphor layer with respect to the barrier ribs illustrated in FIG. 7;

FIG. 9 illustrates a cross-sectional view of a PDP along line IX-IX of FIG. 7;

FIG. 10 illustrates a cross-sectional view of a PDP along line X-X of FIG. 7;

FIG. 11 illustrates a manufacturing flowchart of a PDP according to another exemplary embodiment of the present invention; and

FIGS. 12A-12C illustrate cross-sectional views of sequential stages in a method of manufacturing a PDP according to another embodiment of the present invention.

### DETAILED DESCRIPTION OF THE INVENTION

Korean Patent Application No. 10-2007-0117981, filed on Nov. 19, 2007, in the Korean Intellectual Property Office, and entitled: “Plasma Display Panel and Manufacturing Method of Same,” is incorporated by reference herein in its entirety.

Exemplary embodiments of the present invention will now be described more fully hereinafter with reference to the accompanying drawings, in which exemplary embodiments of the invention are illustrated. Aspects of the invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of elements, layers, and regions may be exaggerated for clarity of illustration. It will also be understood that when an element and/or layer is referred to as being “on” another element, layer and/or substrate, it can be directly on the other element, layer, and/or substrate, or intervening elements and/or layers may also be present. Further, it will be understood that the term “on” can indicate solely a vertical arrangement of one element and/or layer with respect to another element and/or layer, and may not indicate a vertical orientation, e.g., a horizontal orientation. In addition, it will also be understood that when an element and/or layer is referred to as being “between” two elements and/or layers, it can be the only element and/or layer between the two elements and/or layers, or one or more intervening elements and/or layers may also be present. Further, it will be understood that when an element and/or layer is referred to as being “connected to” or “coupled to” another element and/or layer, it can be directly connected or coupled to the other element and/or layer, or intervening elements and/or layers may be present. Like reference numerals refer to like elements throughout.

A PDP according to an exemplary embodiment of the present invention will now be described with reference to the figures.

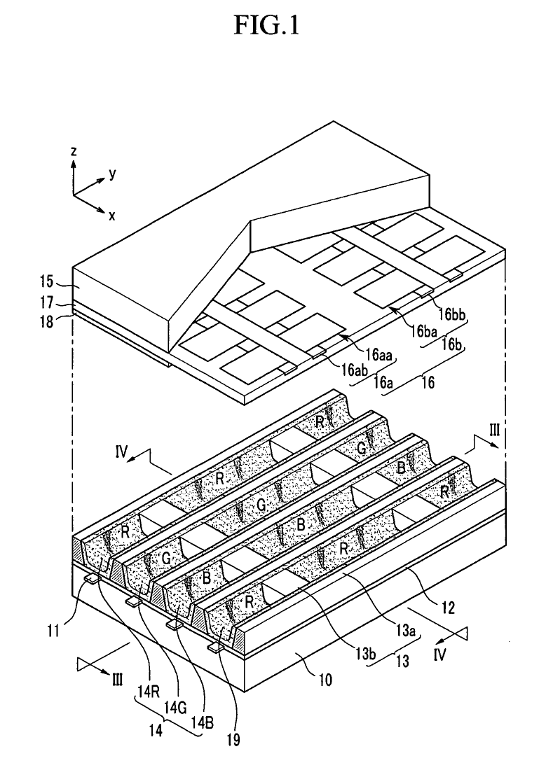

FIG. 1 illustrates an exploded perspective view of a PDP according to an exemplary embodiment of the present invention. Referring to FIG. 1, a PDP may include a rear substrate 10, a front substrate 15, barrier ribs 13 between the rear and front substrates 10 and 15 to define a plurality of discharge cells 19, and a phosphor layer 14. In addition, as illustrated in FIG. 1, the PDP may include display electrodes 16 and address electrodes 11 corresponding to the discharge cells 19. An inert discharge gas, e.g., neon (Ne), xenon (Xe), or a mixture thereof, may be filled into the discharge cells 19, so the discharge gas may generate a discharge in the discharge cells 19 when voltage is applied to the display electrodes 16 to trigger emission of visible light from the phosphor layer 14.

The rear substrate 10 and the front substrate 15 may face each other, and may be spaced apart to have a space therebetween. The barrier ribs 13, the discharge cells 19, the display electrodes 16, and the address electrodes 11 may be arranged in the space between the rear and front substrates 10 and 15.

The address electrodes 11 may extend along a first direction, e.g., the y-axis, on the rear substrate 10. The address electrodes 11 may be arranged in parallel to each other, and may have a predetermined interval therebetween. As illustrated in FIG. 1, a rear dielectric layer 12 may be formed on the rear substrate 10 to cover the address electrodes 11, so the address electrodes 11 may be between the rear substrate 10 and the dielectric layer 12. The address electrodes 11 may be formed of a chemically stable material, i.e., a material not reacting with the rear dielectric layer 12 or the rear substrate 10. For example, the address electrodes 11 may include a metallic material having high conductivity, e.g., silver (Ag).

The display electrodes 16 may extend along a second direction, e.g., the x-axis, on the front substrate 15. The display electrodes 16 may be arranged in parallel to each other, and may have a predetermined interval therebetween. The display electrodes 16 may include a plurality of electrode pairs, each electrode pair including one sustain electrode 16a and one scan electrode 16b. Each of the sustain electrodes 16a and scan electrodes 16b may include transparent electrodes 16aa and 16ba, respectively, and bus electrodes 16ab and 16bb, respectively.

The respective transparent electrodes 16aa and 16ba of each pair of sustain and scan electrodes 16a and 16 may be arranged to be spaced apart from each other to form a discharge gap therebetween. Further, the transparent electrodes 16aa and 16ba may be formed of a transparent material, e.g., indium tin oxide (ITO), so that visible light may be efficiently transmitted therethrough. In order to minimize a relatively high electrical resistance of the transparent electrodes 16aa and 16ba, i.e., to increase conductivity, the bus electrodes 16ab and 16bb may be formed of a metallic material with high conductivity, e.g., Ag or Cr/Cu/Cu, to efficiently apply voltage to the transparent electrodes 16aa and 16ba.

As illustrated in FIG. 1, a front dielectric layer 17 may be formed on the front substrate 15 to cover the display electrodes 16, so the display electrodes 16 may be between the front substrate 15 and the front dielectric layer 17. The front dielectric layer 17 may protect the display electrode 16 from discharged particles. In addition, wall charges may be accumulated on the front dielectric layer 17 to generate a discharge in the discharge cells 19.

As further illustrated in FIG. 1, a protection layer 18 may be formed on the front dielectric layer 17 to face the barrier ribs 13. The protection layer 18 may be formed of a transparent material so visible light emitted from the phosphor layer 14 may be efficiently transmitted through the protection layer 18. The protection layer 18 may protect the front dielectric layer 17 from the discharge, and may increase a secondary electron emission coefficient to reduce a discharge firing voltage. The protection layer 18 may be formed of, e.g., magnesium oxide (MgO).

As illustrated in FIG. 1, the barrier ribs 13 may be formed in the space between the rear and front substrates 10 and 15. In particular, the barrier ribs 13 may be arranged between the protection layer 18 and the rear dielectric layer 12 to define the discharge cells 19. The barrier ribs 13 may include first barrier rib members 13a and second barrier rib members 13b.

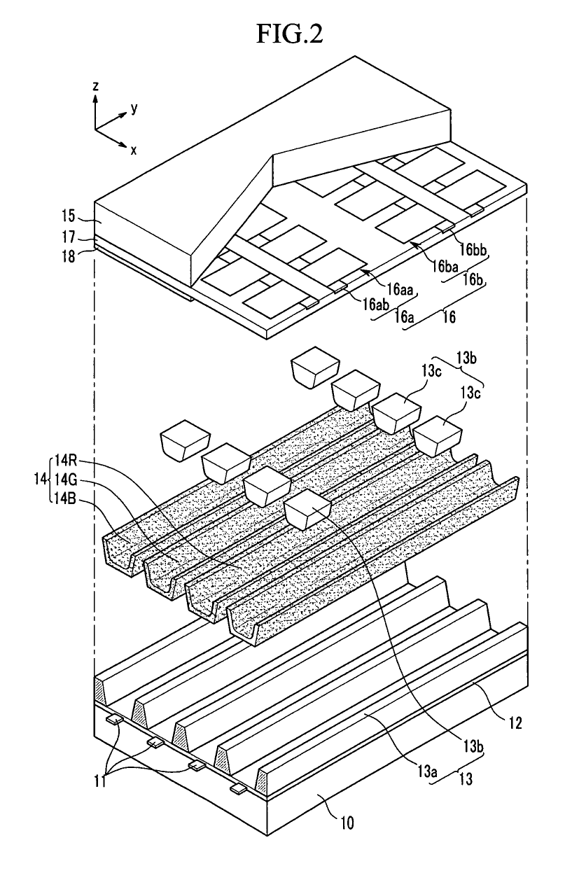

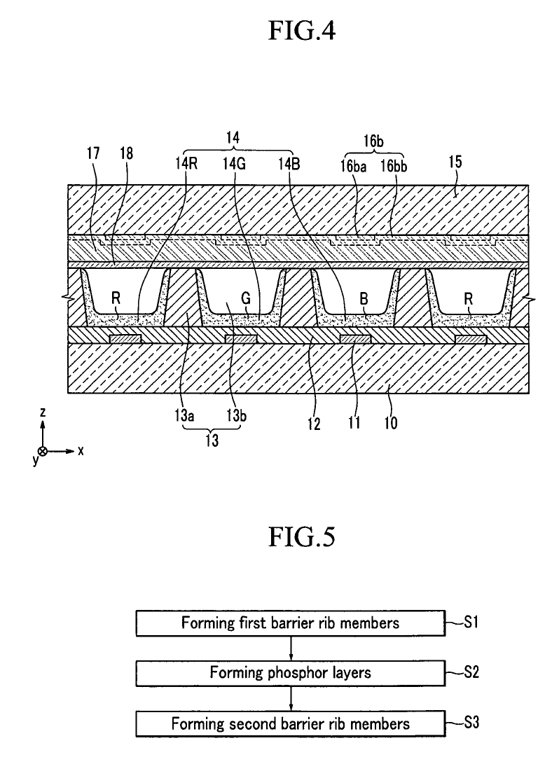

The first barrier rib members 13a and the second barrier rib members 13b may be arranged in any suitable configuration to define the discharge cells 19 in any suitable shape, e.g., a matrix format, a stripe pattern, or a delta pattern. As illustrated in FIG. 2, the first barrier rib members 13a may have a linear structure, and may extend along the first direction, e.g., the y-axis, on the rear substrate 10. For example, the first barrier rib members 13a may be formed in a stripe pattern, i.e., two adjacent first barrier rib members 13a may be parallel and have a space therebetween, on the rear dielectric layer 12. As further illustrated in FIG. 2, a width of each first barrier rib member 13a along the second direction, e.g., the x-axis, may decrease as a height of the first barrier rib member 13a along a third direction, e.g., the z-axis, increases. For example, as illustrated in FIG. 4, cross-sections of the first barrier rib members 13a in the xz-plane may be trapezoidal.

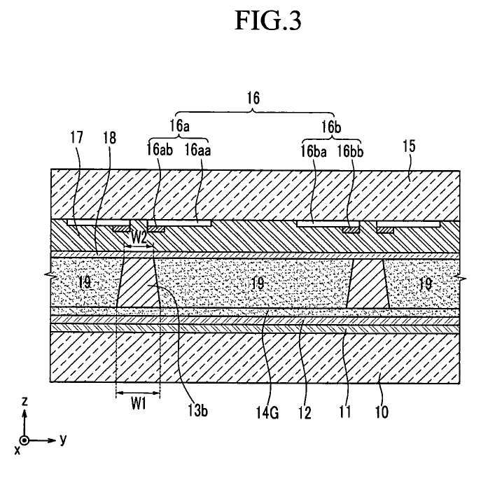

As illustrated in FIG. 2, the second barrier rib members 13b of the PDP may extend along the second direction on the phosphor layer 14, and may include a plurality of discrete segments spaced apart from each other along the second direction. For example, as illustrated in FIG. 2, each second barrier rib member 13b may include a plurality of barrier rib segments 13c along the second direction, e.g., along the x-axis. The barrier rib segments 13c of all the second barrier rib members 13b may form, e.g., a matrix pattern on the phosphor layer 14, so each barrier rib segment 13c may be spaced apart from an adjacent barrier rib segment 13c along the first and second directions, i.e., along both the x-axis and the y-axis. In other words, the second barrier rib members 13b may be arranged along the x-axis to have spaces therebetween along the y-axis. Spaces formed between adjacent barrier rib segments 13c along the y-axis, i.e., barrier rib segments of adjacent second barrier rib members 13b, may define the discharge cells 19, as illustrated in FIG. 3.

As illustrated in FIG. 3, a width of the second barrier rib members 13b along the second direction, e.g., the x-axis, may increase as a height of the second barrier rib member 13b along the third direction, e.g., the z-axis, increases. As illustrated in FIG. 4, a length of the second barrier rib members 13b along the first direction, e.g., the y-axis, may decrease as a height of the second barrier rib members 13b along the third direction, e.g., the z-axis, increases in order to correspond to a varying width of a respective first barrier rib member 13a. For example, as further illustrated in FIG. 4, cross-sections of the second barrier rib members 13b in the yz-plane may be inverted trapezoidal with respect to the trapezoidal cross-sections of the first barrier rib members 13a.

As illustrated in FIG. 1, the phosphor layer 14 of the PDP may include a red phosphor layer 14R for generating red visible light, a green phosphor layer 14G for generating green visible light, and/or a blue phosphor layer 14B for generating blue visible light. The red, green, and blue phosphor layers 14R, 14G, and 14B may be arranged in any suitable arrangement in spaces between adjacent first barrier rib members 13a. For example, as illustrated in FIGS. 1-2, the red phosphor layer 14R may extend along the first direction between two adjacent first barrier rib members 13a, and the green and blue phosphor layers 14G and 14B may be sequentially arranged along the first direction and adjacent to the red phosphor layer 14R along the second direction, e.g., the x-axis.

The phosphor layer 14 may be deposited to coat sidewalls of the first barrier rib members 13a and an upper surface of the rear dielectric layer 12, i.e., a surface facing the barrier ribs 13. In particular, as illustrated in FIGS. 2-4, the phosphor layer 14 may be between the second barrier rib members 13b and the rear dielectric layer 12 along a vertical direction, i.e., as determined along the z-axis in both xz and yz-planes. The phosphor layer 14 may be between the first barrier rib members 13a and the second barrier rib members 13b along a horizontal direction, i.e., along the x-axis as seen in the xz-plane. In other words, the second barrier rib members 13b may be arranged on the upper surface of the phosphor layer 14, i.e., a surface facing the display electrodes 16, so the phosphor layer 14 may overlap and be on three surfaces of each barrier rib segment 13c, as illustrated in FIGS. 2-4. For example, the phosphor layer 14 may surround and be directly on bottom surfaces of the second barrier rib members 13b, i.e., surfaces facing the address electrodes 11, and on outer surfaces of the barrier rib segments 13c, i.e., surfaces facing the first barrier rib members 13a. Accordingly, upper surfaces of the second barrier rib members 13b, i.e., surfaces facing the display electrodes 16, and inner surfaces of the second barrier rib members 13b, i.e., surfaces in the xz-plane that define inner sidewalls of the discharge cells 19, may not overlap or be in direct contact with the phosphor layer 14.

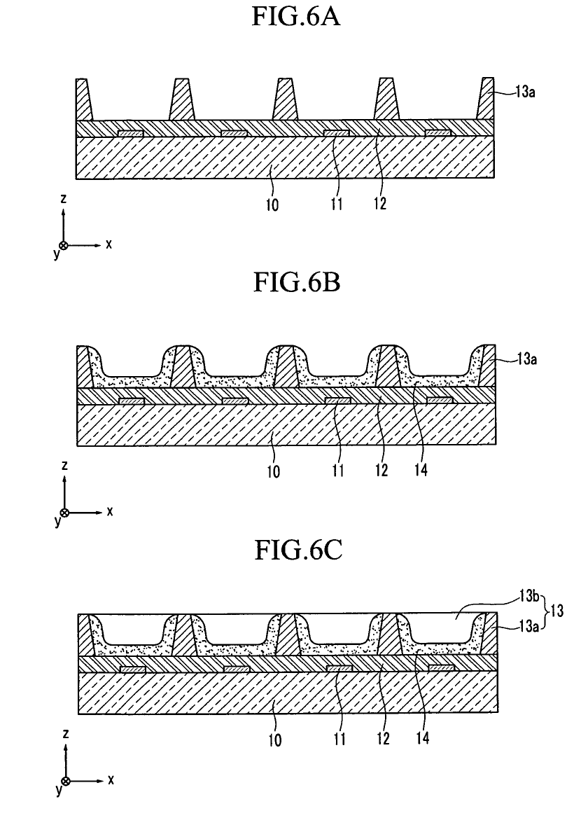

A method of manufacturing the PDP will be explained in more detail below with reference to FIGS. 5-6C. FIG. 5 illustrates a manufacturing flowchart of the PDP according to an exemplary embodiment of the present invention. FIGS. 6A-6C illustrate cross-sectional view of sequential steps in a method of manufacturing the PDP according to an embodiment of the present invention.

As illustrated in FIG. 5, a manufacturing process of the PDP may include a first barrier rib member forming step S1, a phosphor layer forming step S2, and a second barrier rib member forming step S3. Referring to FIGS. 2 and 5, the first barrier rib members 13 a may be formed on the rear substrate 10 in the first barrier rib member forming step S1. Next, in the phosphor layer forming step S2, a phosphor paste may be dispensed between adjacent first barrier rib members 13a to form the phosphor layer 14. Then, in the second barrier rib member forming step S3, the second barrier rib members 13b may be formed on the phosphor layer 14.

In detail, as illustrated in FIG. 6A, the first barrier rib members 13a may be formed on the rear dielectric layer 12 by, e.g., a molding method, an etching method, or a sandblast method. Subsequently, as illustrated in FIG. 6B, the phosphor layer 14 may be formed between adjacent first barrier rib members 13a by, e.g., a dispensing method. Then, as illustrated in FIG. 6C, the second barrier rib members 13b may be formed on the upper surface of the phosphor layer 14 by, e.g., a molding method or a dispensing method, such that the phosphor layer 14 may envelop three surfaces of each of the barrier rib segments 13c. Accordingly, a portion of the phosphor layer 14 may be between the first and second barrier rib members 13a and 13b, and a portion of the phosphor layer may also be between the second barrier rib members 13b and the rear dielectric layer 12.

The dispensing method may include a spraying method for spraying a paste by using a spraying nozzle (not shown). The paste of the dispensing method may include a barrier rib forming paste or a phosphor layer forming paste.

The molding method may include preparation of a mold with a depressed engraving therein, i.e., the depressed engraving may have a barrier rib shape. The mold may be formed of, e.g., one or more of plastic, rubber, a steel alloy, a titanium alloy, an aluminum alloy, and so forth. Subsequently, a barrier rib forming paste may be deposited in the mold, followed by heating of the mold to solidify the paste. Next, the solidified paste may be removed from the mold. It is noted that since a first width W1 of a lower part of the second barrier rib members 13b is wider than a second width W2 of an upper part of the second barrier rib members 13b, as illustrated in FIG. 3, a tapered angle may be formed in the mold during formation of the second barrier rib member 13b. The tapered angle in the mold may facilitate separation of the solidified paste forming the second barrier ribs member 13b from the mold.

Formation of the second barrier rib members 13b after formation of the phosphor layer 14 may improve image quality of the PDP. In particular, formation of the second barrier rib members 13b on the upper surface of the phosphor layer 14 may minimize coverage of the second barrier rib members 13b by the phosphor layer 14, e.g., upper and inner surface of the second barrier rib members 13b may not be covered by the phosphor layer 14, so discharge and visible light emission may be improved. In contrast, if a phosphor layer is formed after formation of the first and second barrier rib is complete, the phosphor layer may coat upper and inner surfaces of the second barrier rib members, so an erroneous discharge may be triggered or unnecessary visible light may be generated, thereby deteriorating image quality.

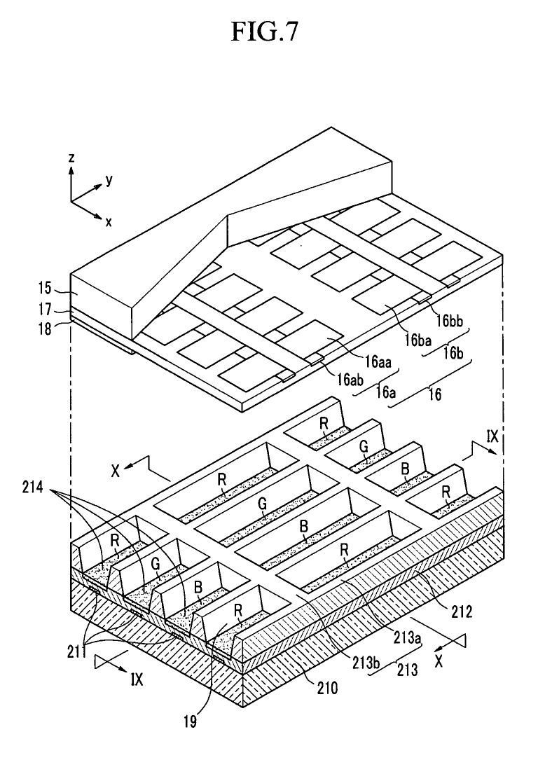

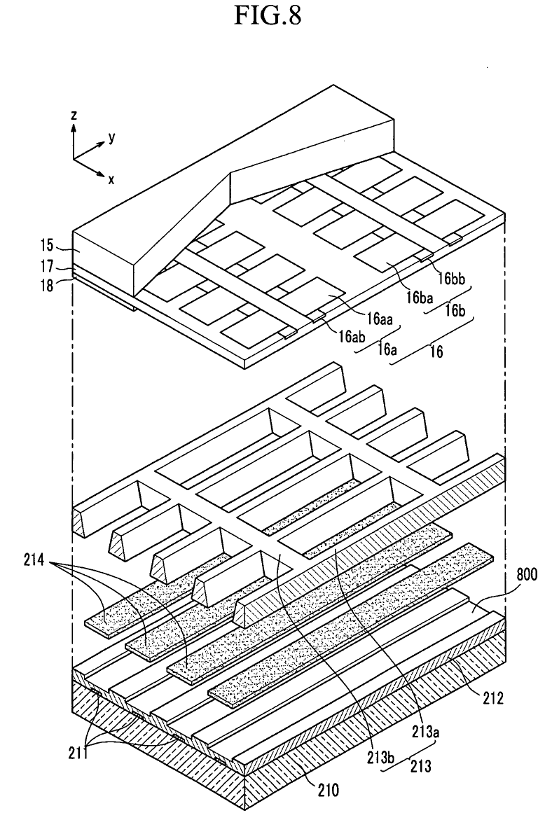

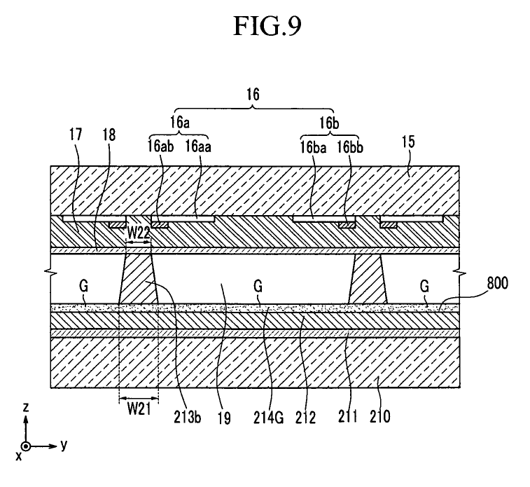

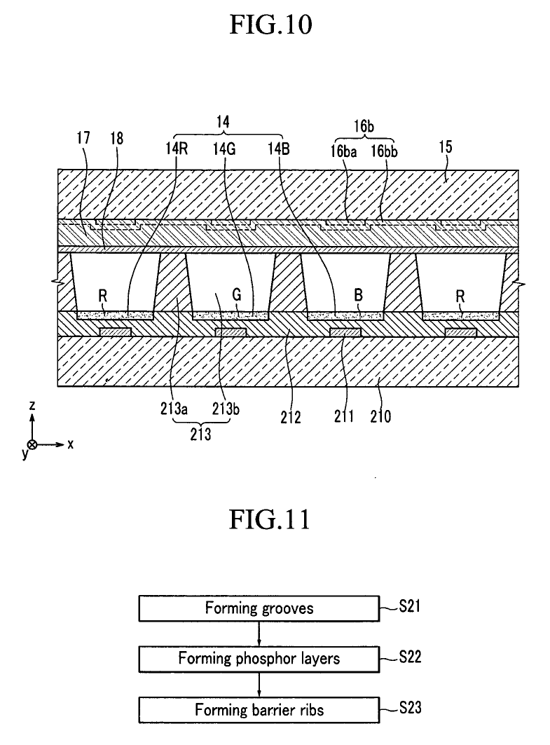

A PDP according to another exemplary embodiment will be explained in more detail below with reference to FIGS. 7-10. FIG. 7 illustrates an exploded perspective view of the PDP according to an exemplary embodiment of the present invention, FIG. 8 illustrates a perspective view of a phosphor layer and a barrier rib in FIG. 7, FIG. 9 illustrates a cross-sectional view of the PDP along line IX-IX of FIG. 7, and FIG. 10 illustrates a cross-sectional view of the PDP along line X-X of FIG. 7.

Referring to FIGS. 7-8, a PDP may include a rear substrate 210, the front substrate 15, barrier ribs 213 between the rear and front substrates 210 and 15 to define the plurality of discharge cells 19, a phosphor layer 214, and grooves 800 in a rear dielectric layer 212 along the address electrodes 11. The front substrate 15, the display electrodes 16, the front dielectric layer 17, and the protection layer 18 may be substantially same as described previously with reference to FIGS. 1-6C, and therefore, their detailed description will not be repeated.

The barrier ribs 213 may include first barrier rib members 213a and second barrier rib members 213b. The first and second barrier rib members 213a and 213b may be formed on the rear dielectric layer 212 by, e.g., a molding method, to have any suitable structure, e.g., a grid pattern. For example, the first barrier rib members 213a may extend along the first direction, and the second barrier rib members 213b may extend along the second direction to cross the first barrier rib members 213a. The first barrier rib members 213a and the second barrier rib members 213b may define the discharge cells 19 to have, e.g., a matrix pattern.

Referring to FIGS. 8-10, the phosphor layer 214 may have a substantially same composition as the phosphor layer 14 described previously with reference to FIGS. 1-6C, and may be formed in the grooves 800. For example, the phosphor layer 214 may be deposited directly in the grooves 800, so an upper surface of the phosphor layer 214 may be substantially level with an upper surface of the rear dielectric layer 212. A thickness of the phosphor layer 214 along the z-axis may substantially equal a depth of the grooves 800 along the z-axis. A width of the grooves 800, i.e., a distance as measured along the x-axis, may substantially equal a distance along the x-axis between adjacent first barrier rib members 213a. Other configurations of the phosphor layer 214 with respect to the grooves 800, e.g., the thickness of the phosphor layer 214 may be different than the depth of the grooves 800 and/or the width of the grooves 800 may be shorter than the distance between adjacent first barrier rib members 2134, are within the scope of the present invention. It is further noted that since the grooves 800 may overlap the address electrodes 11, a total thickness of the rear dielectric layer 212 along the z-axis may be larger than a sum of the depth of the grooves 800 and a thickness of the address electrodes 11. In other words, a portion of the rear dielectric layer 212 may be positioned between each groove 800 and a respective address electrode 11.

Since the phosphor layer 214 is in the grooves 800, the phosphor layer 214 may not be directly on side surfaces or upper surfaces of the first and second barrier rib members 213a and 213b. In addition, as illustrated in FIG. 9, the phosphor layer 214 may be formed between the second barrier rib members 213b and the rear dielectric layer 212.

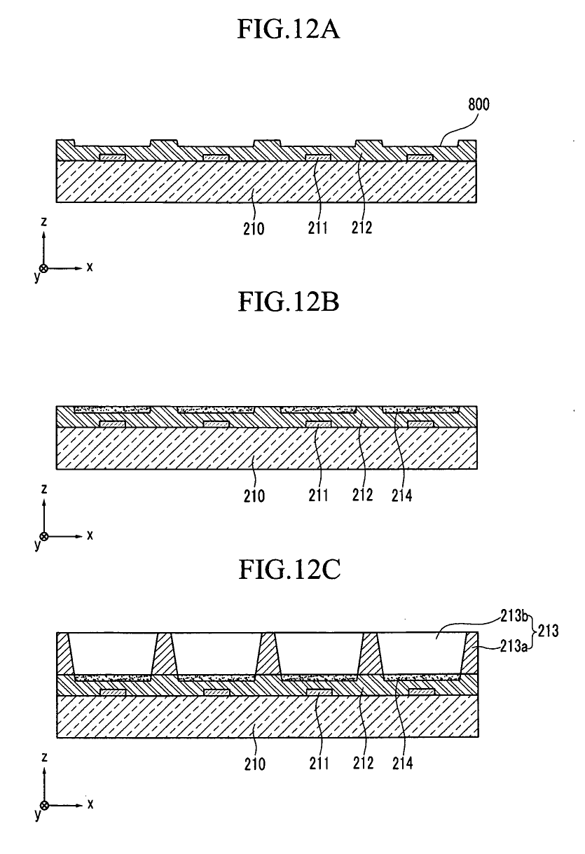

The PDP illustrated in FIGS. 7-10 may be manufactured according to an embodiment illustrated in FIGS. 11-12C. FIG. 11 illustrates a manufacturing flowchart of the PDP according to an embodiment of the present invention, and FIGS. 12A-12C illustrate cross-sectional views of sequential steps in a method of manufacturing the PDP according to an exemplary embodiment of the present invention.

As illustrated in FIG. 11, a manufacturing process according to an exemplary embodiment of the present invention may include a groove forming step S21, a phosphor layer forming step S22, and a barrier rib forming step S23. In particular, as illustrated in FIGS. 8 and 11, the grooves 800 may be formed on the rear substrate 210 by an etching method in the groove forming step S21, the phosphor paste may be dispensed in the groove 800 to form the phosphor layer 214 in the phosphor layer forming step S22, and the barrier rib 213 may be formed on the rear substrate 210 and the phosphor layer 214 by the molding method in the barrier rib forming step S23.

In detail, as illustrated in FIG. 12A, the grooves 800 may be formed on the rear dielectric layer 212. Subsequently, as illustrated in FIG. 12B, the phosphor layer 214 may be formed in the groove 800. Then, as illustrated in FIG. 6C, the barrier rib 213 may be formed on the rear dielectric layer 212. The phosphor layer 214 may be formed by, e.g., the dispensing method, and the barrier rib 213 may be formed by, e.g., the molding method. A first width W21 of a lower part of the second barrier rib member 213b may be wider than a second width W22 of an upper part of the second barrier rib member 213b, as illustrated in FIG. 9. As described previously with reference to FIGS. 3-4, the width difference may facilitate formation of a tapered angle in the second barrier ribs 213b during the molding process, thereby facilitating separation of the mold when the barrier rib paste is solidified. In a like manner, an upper width of the first barrier rib member 213a may be narrower than a lower width thereof.

Formation of the barrier ribs 213 after formation of the phosphor layer 214 may improve image quality of the PDP. In particular, formation of the barrier rib 213 after formation of the phosphor layer 214 may minimize coverage of the barrier ribs 213 by the phosphor layer 214, e.g., upper surfaces of the barrier ribs 213, so discharge and visible light emission may be improved. In contrast, if a phosphor layer is formed after formation of the first and second barrier rib is complete, the phosphor layer may at least partially cover upper surfaces of the barrier ribs, so an erroneous discharge may be triggered or unnecessary visible light may be generated, thereby deteriorating image quality.

As described above, a PDP according to exemplary embodiments of the present invention may include at least second barrier rib members formed after the phosphor layer, so the phosphor may not be formed on the upper surfaces of the second barrier rib members. Therefore, a misfiring discharge caused by the phosphor that is unnecessarily formed on the upper surface of the barrier rib may be reduced. In addition, since the phosphor is not formed on the upper surfaces of the barrier rib, a front panel, i.e., the front substrate with the front dielectric layer and the protection layer, may be formed directly on the barrier rib. Accordingly, a gap between the front panel and the barrier ribs may not be formed, thereby minimizing noise and crosstalk between adjacent discharge cells. Further, since the barrier rib may be formed after the phosphor layer is formed in a groove of a rear dielectric layer, the phosphor may not be formed on the upper surface of the barrier rib. Therefore, the misfiring discharge caused by the phosphor that is unnecessarily formed on the upper surface of the barrier rib may be reduced. In addition, since the first barrier rib member or the second barrier rib member is formed after the phosphor layer is formed, the phosphor may not be formed on upper surfaces of the first barrier rib member or the second barrier rib member. Also, since the first barrier rib member or the second barrier rib member is formed by the molding method, the lower width of the barrier rib may be formed to be greater than the upper width.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel (PDP), comprising:
front and rear substrates spaced apart and facing each other;
a plurality of display electrodes along a first direction on the front substrate;
a plurality of address electrodes along a second direction on the rear substrate, the second direction crossing the first direction;
a dielectric layer on the rear substrate to cover the address electrodes;
barrier ribs between the front and rear substrates to define a plurality of discharge cells, a bottom surface of the barrier ribs being on the dielectric layer; and
a phosphor layer on the dielectric layer, at least one portion of the phosphor layer being arranged between the dielectric layer and the bottom surface of the barrier ribs.

2. The PDP as claimed in claim 1, wherein the barrier ribs include first barrier rib members extending directly on the dielectric layer and second barrier rib members arranged directly on the phosphor layer along a direction crossing a direction of the first barrier rib members, the at least one portion of the phosphor layer being positioned between the dielectric layer and a bottom surface of the second barrier rib members.

3. The PDP as claimed in claim 2, wherein the phosphor layer overlaps and is in direct contact with three surfaces or less of the second barrier rib members.

4. The PDP as claimed in claim 3, wherein the phosphor layer overlaps and is in direct contact with the bottom surfaces and outer surfaces of the second barrier rib members, the outer surfaces of the second barrier rib members facing the first barrier rib members.

5. The PDP as claimed in claim 3, wherein the phosphor layer overlaps and is in direct contact only with the bottom surfaces of the second barrier rib members.

6. The PDP as claimed in claim 2, wherein the phosphor layer is not on upper surfaces or inner surfaces of the second barrier rib members, the upper surfaces of the second barrier rib members being opposite the bottom surfaces, and the inner surfaces of the second barrier rib members defining inner sidewalls of the discharge cells.

7. The PDP as claimed in claim 6, wherein the phosphor layer is not on upper surfaces or inner surfaces of the first barrier rib members.

8. The PDP as claimed in claim 2, wherein at least one portion of the phosphor layer is arranged between a second barrier rib member and an immediately adjacent first barrier rib member.

9. The PDP as claimed in claim 8, wherein each second barrier rib member includes a plurality of discrete barrier rib segments, each barrier rib segment being positioned directly on the phosphor layer between two adjacent first barrier rib members.

10. The PDP as claimed in claim 1, wherein the dielectric layer includes a groove along the second direction, the phosphor layer being in the groove.

11. A method of manufacturing a plasma display panel (PDP), comprising:
forming a plurality of display electrodes along a first direction on a front substrate;
forming a plurality of address electrodes along a second direction on a rear substrate, the front and rear substrates spaced apart and facing each other;
forming a dielectric layer on the rear substrate to cover the address electrodes;
forming barrier ribs between the front and rear substrates to define a plurality of discharge cells, such that a bottom surface of the barrier ribs is on the dielectric layer; and
forming a phosphor layer on the dielectric layer, such that at least one portion of the phosphor layer is formed between the dielectric layer and the bottom surface of the barrier ribs.

12. The manufacturing method as claimed in claim 11, wherein forming the barrier ribs and the phosphor layer includes:
forming first barrier rib members on the dielectric layer, the first barrier ribs being spaced apart from each other;
forming the phosphor layer between adjacent first barrier rib members, the phosphor layer being on the dielectric layer and on sidewalls of the first barrier rib members; and
forming second barrier rib members on the phosphor layer.

13. The manufacturing method as claimed in claim 12, wherein forming the second barrier rib members includes using a mold.

14. The manufacturing method as claimed in claim 12, wherein forming the second barrier rib members includes dispensing a barrier rib forming paste.

15. The manufacturing method as claimed in claim 12, wherein forming the phosphor layer includes dispensing a phosphor paste.

16. The manufacturing method as claimed in claim 11, wherein forming the barrier ribs and the phosphor layer includes:
forming a groove in the dielectric layer along the second direction;
forming the phosphor layer in the groove; and
forming the barrier ribs on the rear substrate, at least a portion of the barrier ribs overlapping the phosphor layer.
